(19) United States
(12) Patent Application Publication
(10) Pub. No.: US 2005/0132099 A1
(43) Pub. Date: Jun. 16, 2005

(54) Network system, and device, method and program for controlling host interface

(76) Inventor: Kazuya Honma, Tokyo (JP)

Correspondence Address: YOUNG & THOMPSON, 745 SOUTH 23RD STREET, 2ND FLOOR, ARLINGTON, VA, 22202, US

(21) Appl. No.: 11/009,009

(22) Filed: Dec. 13, 2004

(30) Foreign Application Priority Data
Dec. 12, 2003 (JP) 2003-414919

(51) Int. Cl. G06F 3/00

(52) U.S. Cl. 710/15

(57) ABSTRACT

To save the command processing period when a Read Command is issued from a host, in which a Delayed ACK works, to a disk array apparatus, and to speed up host set-up processing, disk recognition processing, batch processing and the like. A host adapter counts the number of PDUs transmitted to the host, and if only one PDU has been transmitted, transmits a Nop-In Command PDU to the host, to thereby hasten the response of an ACK signal. Further, when plural PDUs are transmitted, a transmission of a Nop-In Command PDU is prevented so as to reduce the load on the TCP/IP network.

### BACKGROUND OF THE INVENTION

1. Field of the Invention

The present invention relates to a network system for processing commands between a host computer (hereinafter simply referred to as a “host”) and peripheral equipment connected with each other over a communication network, and a host interface control device and the like related thereto.

2. Related Art

Today, the iSCSI protocol, enabling to perform operations by connecting storages such as disk array apparatuses with the Internet directly, is proposed by the Internet Engineering Task Force in the United States. The iSCSI protocol is developed to perform SCSI processing on the TCP (Transmission Control Protocol) defined in the RFC (Request for Comments) 793 and RFC1122 by the IETF (see, for example, Japanese Patent Application No. 2003-162495).

Here, the interface flow in command processing of the iSCSI will be described with reference to the drawings. Commands of the iSCSI are transmitted and received in units called PDUs (Protocol Data Units), and ACK signals of the TCP are used for response.

FIG. 1 shows the interface flow when a Write Command is issued from a host to a disk array apparatus.

In FIG. 1, the host issues a Write Command PDU and transmits the command to the disk array apparatus (Step 901). The disk array apparatus receives the command, and returns an ACK signal, indicating that it received the command, to the host (Step 902).

Then, the disk array apparatus performs preparation such as securing a reception buffer for receiving write data, and transmits an R2T PDU, indicating the preparation has been completed, to the host (Step 903), and waits for an ACK signal from the host (Step 904).

Upon receipt of the R2T PDU from the disk array apparatus, the host transmits a Data-Out PDU including write data to the disk array apparatus (Step 905). Then, the disk array apparatus transmits an ACK signal to the host (Step 906), and writes the received data onto a storage medium such as a cache memory or a magnetic disk device.

Finally, the disk array apparatus transmits a Response PDU, indicating the result of executing a command for writing the data received from the host, to the host (Step 907). Upon receipt of the Response PDU, the host transmits an ACK signal to the disk array apparatus (step 908).

Here, a period from the time the host issues a Write Command PDU to the disk array apparatus (Step 901) up to the time the host receives a Response PDU from the disk array apparatus (Step 907) constitutes a processing period 909 for processing the Write Command.

Similarly, FIG. 2 shows the interface flow when the host issues a Read Command to the disk array apparatus.

In FIG. 2, the host issues a Read Command PDU and transmits the command to the disk array apparatus (Step 101). The disk array apparatus returns an ACK signal indicating that it received the command (Step 102).

Then, the disk array apparatus reads data out of a storage medium such as a cache memory or a magnetic disk device, and prepares and transmits a Data-In PDU to the host (Step 103).

Upon receipt of the data from the disk array apparatus, the host returns an ACK signal, indicating that it received the data, to the disk array apparatus (Step 104).

Finally, the disk array apparatus transmits a Response PDU indicating the result of executing the command to the host (Step 105), and the host transmits an ACK signal, indicating the response thereto, to the disk array apparatus (Step 106).

Here, a period from the time the host issues the Read Command PDU to the disk array apparatus (Step 101) up to the time the host receives the Response PDU from the disk array apparatus (Step 105) constitutes a Read Command processing period 107 in the host.

Further, RFC1122 includes a definition for responses of the ACK signals. This is called a Delayed ACK, which delays transmission of an ACK signal from the host so as to reduce the load on the network. According to the definition, a transmission of an ACK signal from the host is set to be delayed for 0.5 second at most, or until two or more packets are received.

However, if the iSCSI is operated in the circumstance that a host conforming to the definition of the Delayed ACK is connected with a disk array apparatus, the following problem is caused.

In the Read Command processing shown in FIG. 2, when the host activates the operation of the Delayed ACK, the command processing period (107 in FIG. 2) increases, which causes a problem that the disk array apparatus cannot fully exhibit the performance originally held by the apparatus.

The reason is as follows. In a case where the disk array apparatus transmits a Data-In PDU to the host and waits for an ACK signal from the host (108 in FIG. 10), if the host issued only one command to the disk array apparatus, an ACK response from the host is delayed for 0.5 second at most since the Delayed ACK is activated.

Further, if a disk array apparatus is connected with a host in which the OS is a Windows system, processing periods for host set-up processing, disk recognition processing, batch processing by applications and the like, in which I/O processing is performed sequentially, increase due to the aforementioned problem.

### SUMMARY OF THE INVENTION

It is therefore an object of the present invention to provide, in a network where a host delays response signals corresponding to commands from peripheral equipment, a network system in which the delay by the host is released so as to output the response signals promptly, and to provide a host interface controller, a networking method, a host interface controlling method, and a network control program, related thereto.

Further, if the present invention is applied to a network system in which the standard is the iSCSI and the peripheral equipment is a disk array apparatus, an object is, when the host in which the Delayed ACK is operable is connected with the disk array apparatus, to perform command processing without degrading the command processing period even when the host issues only one Read Command. A second object is, in a case where the host supporting the Delayed ACK is connected with the disk array apparatus, to enable command processing without increasing the load on the network even when the host issues plural commands. A third object is, even in a case where the host supporting the Delayed ACK is connected with the disk array apparatus, to prevent the processing periods, for host set-up processing, disk recognition processing, batch processing by applications and the like, from increasing.

In order to achieve the aforementioned objects, a network system of the present invention comprises: a host computer which outputs a response signal corresponding to a command in accordance with a standard; and peripheral equipment which is connected with the host computer over a communication network and outputs the command to the host computer. The standard of the host computer is so defined as to delay a transmission of the response signal corresponding to the command from the peripheral equipment until either of conditions is satisfied: a prescribed time period has elapsed since the host computer received the command; and the number of commands outputted from the peripheral equipment reaches the prescribed number. The peripheral equipment has response signal urging means for transmitting response signal urging commands of the number satisfying the prescribed number of commands defined in the standard of the host computer.

After a required command (regular command) is transmitted from the peripheral equipment to the host, response signal urging commands are transmitted additionally to the host so as to make the number of commands that the host received from the peripheral equipment reaches the prescribed number of commands defined in the standard of the host. Thereby, the host returns a response signal to the peripheral equipment. That is, by transmitting response signal urging commands to the host continuously, a response signal from the host can be received promptly, whereby the original processing speed of the peripheral equipment can be realized.

It is worthless to transmit additional commands continuously in spite of the number of commands transmitted to the host having been reached a certain number, since a response signal will be received soon. This also causes to increase the load on the communication network. Therefore, it may be acceptable that, the number of commands transmitted to the host is counted, and response signal urging commands are transmitted to the host only when the number of commands is less than a certain number.

For example, if a response signal urging means operates when the load on the communication network is large, the load becomes larger. In such a case, it is preferable not to operate the response signal urging means. Therefore, whether or not to operate the response signal urging means is determined by a control signal. A device outputting the control signal may be the host, the peripheral equipment itself, or a device controlling the load on the communication network, or the like.

It is preferable to use a TCP/IP network as a communication network, and to use the iSCSI as the standard. It is also preferable to use a Delayed ACK as a signal to delay a transmission of a response signal, to use a Data-In PDU as a required command to request for a response signal from the host, and to use a Nop-In Command PDU as a response signal urging command.

In this case, a Data-In PDU may be used instead of a Nop-In Command PDU, and a storage may be the disk array apparatus.

A networking method of the present invention for performing command processing by using the network system comprises the steps of: delaying, by a host computer received a command from peripheral equipment inputted over a communication network, a transmission of a response signal corresponding to the command from the peripheral equipment until either of the conditions is satisfied: a prescribed time period has elapsed since the host computer received the command; and the number of commands outputted from the peripheral equipment reaches a prescribed number; and transmitting, by the peripheral equipment, response signal urging commands of the number satisfying the prescribed number of commands defined in the standard of the host computer.

Further, a network control program of the present invention preferably includes, a function of causing a host computer, received a command from peripheral equipment inputted over a communication network, to delay a transmission of a response signal corresponding to the command from the peripheral equipment until either of the conditions is satisfied: a prescribed time period has elapsed since the host computer received the command; and the number of commands outputted from the peripheral equipment reaches a prescribed number, and a function of causing the peripheral equipment to transmit response signal urging commands of the number satisfying the prescribed number of commands defined in the standard of the host computer.

If the standard of the host computer is the iSCSI, and the peripheral equipment is a disk array apparatus, the present invention can be configured as follows.

(1) The peripheral equipment connected with the host using Delayed ACK signals is provided with an iSCSI control device. In the iSCSI device, by a means for transmitting a Nop-In Command PDU to the host after a Data-In PDU is transmitted, the host is requested to perform an ACK response responding to the Data-In PDU promptly, while satisfying the iSCSI standard.

(2) In the iSCSI control device described in (1) above, by a means for switching whether or not to transmit a Nop-In Command PDU through counting the number of PDUs transmitted to the host, the host is requested to perform an ACK response promptly, while adjusting the traffic of the network.

(3) In the iSCSI control device described in (1) above, by a means for switching whether or not to transmit a Nop-In Command PDU through an instruction from the outside, the host is requested to perform an ACK response promptly only when it is required.

The present invention is characterized in that right after a Data-In PDU is transmitted from the disk array apparatus to the host, a Nop-In Command PDU is transmitted continuously, whereby the timing of ACK response from the host to the disk array apparatus is hastened by the disk array apparatus itself.

Here, a Nop-In Command PDU is a command for confirming whether a connection between the host and the disk array apparatus is valid. As a response to this, the iSCSI specification defines that the host is required to transmit a Nop-Out Command PDU to the disk array apparatus. Thereby, the command processing period for the Read Command is saved, and the performance held originally by the disk array apparatus can be maintained.

Further, it is characterized as not to transmit a Nop-In Command PDU when plural PDUs are transmitted to the host by counting the number of PDUs transmitted to the host. This can prevent an unnecessary transmission of a Nop-In Command PDU, so that the load on the network can be reduced.

Actions of the present invention are as follows. In the Read Command processing, by transmitting a Data-In PDU and also transmitting a Nop-In Command PDU right after it from the disk array apparatus to the host, the host receives two PDUs. Then, according to the definition of the Delayed ACK, an ACK signal is transmitted promptly to the disk array apparatus. In other words, the disk array apparatus can receive the ACK signal in a shorter period than 0.5 second.

As a result, one command processing period is saved, and consequently, processing periods for host set-up processing, disk recognition processing, batch processing by applications, and the like are saved.

(Effects)

According to the present invention, an additional command is transmitted to the host after a required command is transmitted to the host. Thereby, the number of commands transmitted from the peripheral equipment reaches a certain number, so that a response signal from the host can be received promptly. Therefore, the processing speed of the peripheral equipment can be improved.

Further, the number of commands transmitted to the host is counted, and only when the number of commands is less than a certain number, an additional command is transmitted to the host. This can prevent an unnecessary transmission of a command, and also suppress an increase of the load on the communication network.

Further, by controlling whether or not to operate a response signal urging means, it is possible to realize detailed processing corresponding to, for example, the load situation of the communication network.

Further, the effects of the present invention can be described as follows in the case of the standard being the iSCSI and the peripheral equipment being a disk array apparatus.

A first effect is, when the host issues only one Read Command, to save the command processing period by hastening the transmission of an ACK signal from the host by transmitting a Nop-In Command DPU after a Data-In PDU has been transmitted.

A second effect is not to increase the load on the network when the host issues plural commands, by counting the number of PDUs transmitted from the disk array apparatus to thereby switch whether or not to transmit a Nop-In Command PDU.

### BRIEF DESCRIPTION OF THE DRAWINGS

FIG. 1 is a sequential chart showing the interface flow of a Write Command in a conventional art;

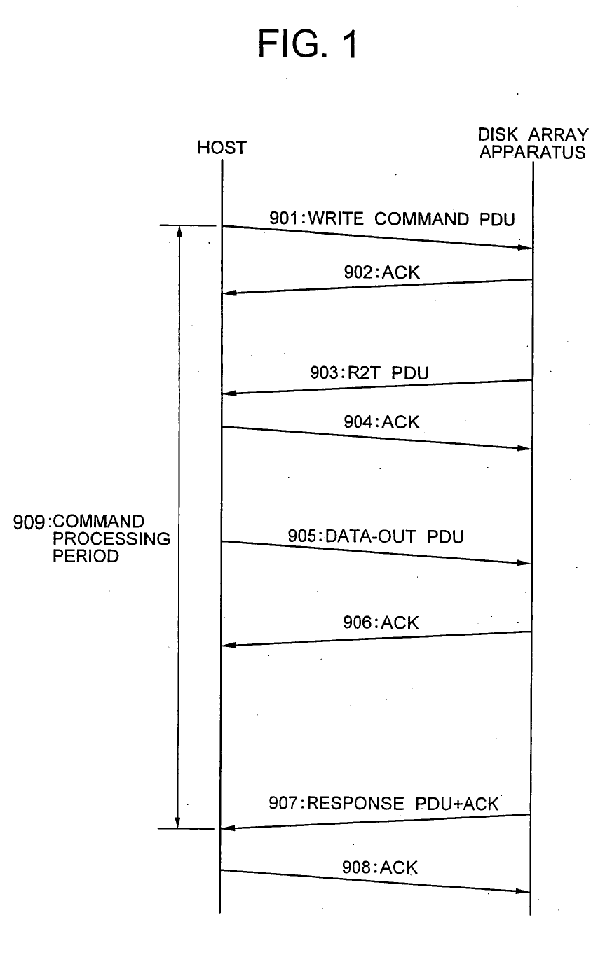

FIG. 2 is a sequential chart showing the interface flow of a Read Command in the conventional art;

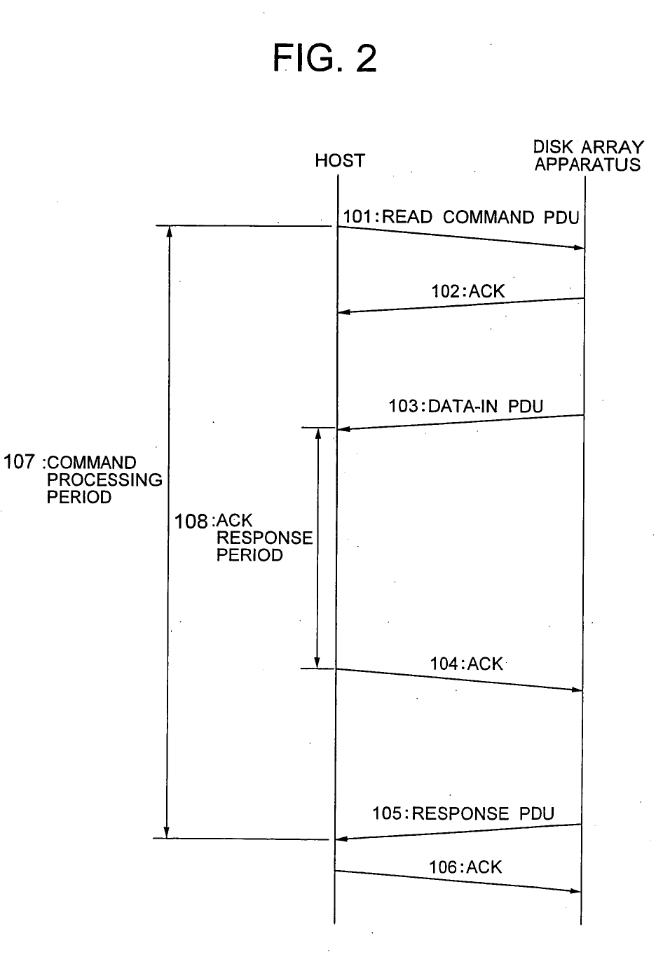

FIG. 3 is a block diagram showing a first embodiment of the present invention;

FIG. 4 is a sequential chart showing the interface flow of a Read Command in the first embodiment;

FIG. 5 is a flowchart showing initialization processing in the first embodiment;

FIG. 6 is a flowchart showing command reception processing in the first embodiment;

FIG. 7 is a flowchart showing data reception processing in the first embodiment;

FIG. 8 is a flowchart showing data transmission processing in the first embodiment;

FIG. 9 is a flowchart showing response transmission processing in the first embodiment; and

FIG. 10 is a sequential chart showing the interface flow of a Read Command in a second embodiment of the present invention.

### PREFERRED EMBODIMENTS OF THE INVENTION

Next, embodiments of the present invention will be described in detail with reference to the drawings.

A network system of the present invention includes: a host computer (1) which outputs response signals corresponding to commands according to the standard; and peripheral equipment (2) which is connected with the host computer (1) over a communication network (14) and outputs the commands to the host computer (1). The standard of the host computer (1) is so defined as to delay a transmission of a response signal corresponding to a command from the peripheral equipment (2) until either of the conditions is satisfied: a prescribed time period has elapsed since the host computer received the command from the peripheral equipment (2); and the number of commands outputted from the peripheral equipment (2) reaches the prescribed number. The peripheral equipment (2) has a response signal urging means for transmitting response signal urging commands satisfying the prescribed number of commands defined by the standard of the host computer (1).

In order to perform command processing between the host computer (1) and the peripheral equipment (2) by using the network system of the present invention (networking method), first, the host computer (1), received a command inputted over the communication network (14) from the peripheral equipment (2), executes a step of delaying a transmission of a response signal corresponding to the command from the peripheral equipment until either of the conditions is satisfied: a prescribed time period has elapsed since the host computer received the command from the peripheral equipment (2), and the number of commands outputted from the peripheral equipment reaches the prescribed number. Further, the peripheral equipment (2) executes a step of transmitting response signal urging commands of the number satisfying the prescribed number of commands defined by the standard of the host computer (1). Through the processing, a response signal is received from the host computer (1) promptly.

In order to perform a networking method by using the network system of the present invention, a network control program of the present invention is used. A network control program according to the present invention executes, a function of causing the host computer (1), which received a command inputted over the communication network from the peripheral equipment (2), to delay a transmission of a response signal corresponding to the command until either of the conditions is satisfied: a prescribed time period has elapsed since the host computer received the command from the peripheral equipment, and the number of commands outputted from the peripheral equipment reaches the prescribed number, and a function of causing the peripheral equipment to transmit response signal urging commands of the number satisfying the prescribed number of commands defined by the standard of the host computer (1).

The peripheral equipment (2) of the present invention is connected, over the communication network (14), with the host computer (1) outputting response signals corresponding to commands according to the standard, and has a function as a host interface control device to output the commands to the host computer (1). Thereby, if there is an existing network system in which the standard of the host computer is so defined as to delay a transmission of a response signal corresponding to a command from the peripheral equipment until either of the conditions is satisfied: a prescribed time period has elapsed since the host computer received the command from the peripheral equipment, and the number of commands outputted from the peripheral equipment reaches the prescribed number, it is possible to use the peripheral equipment according to the present invention as a peripheral equipment of the existing network system. The peripheral equipment of the present invention can serve as a host interface control device with a response signal urging means for transmitting response signal urging commands of the number satisfying the prescribed number of commands defined in the standard of the host computer.

Here, it is preferable that a TCP/IP network be used as the communication network (14) and the iSCSI standard be used as the standard for delaying response signals transmitted from the host computer (1). It is preferable that the host computer (1) output ACK signals as response signals to commands transmitted from the peripheral equipment (2), and output Delayed ACK signals as signals for delaying transmission of the response signals, and that the peripheral equipment (2) use Data-In PDUs as the commands for requesting the host computer (1) for responses, and use Nop-In Command PDUs or Data-In PDUs as the response signal urging commands.

Further, considering a case where there is an existing networking method in which a host computer, receiving a command inputted over a communication network from peripheral equipment, delays the transmission of a response signal corresponding to the command from the peripheral equipment until either of the conditions is satisfied: a prescribed time period has elapsed since the host computer received the command from the peripheral equipment, and the number of commands outputted from the peripheral equipment reaches the prescribed number. In this case, the peripheral equipment of the present invention is to be provided on the existing network, and is caused to execute a step of transmitting response signal urging commands of the number satisfying the prescribed number of commands defined in the standard of the host computer.

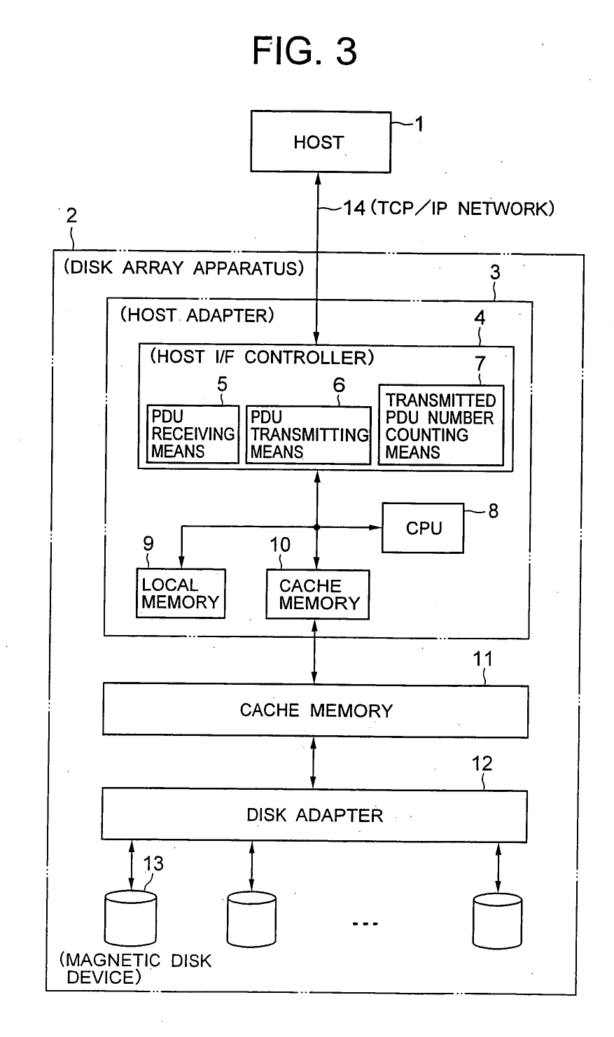

Next, the present invention will be described in detail by using a specific example. FIG. 3 is a block diagram showing a first embodiment of the present invention. Hereinafter, an explanation will be given with reference to this Figure.

In a network system shown in FIG. 3, a host computer (hereinafter referred to as a host) 1 and a disk array apparatus 2 as peripheral equipment are connected with each other over a TCP/IP network 14, which is one of communication networks, so as to perform command processing by using the iSCSI between them.

Here, the iSCSI is used as a communication network, a Delayed ACK is used as the standard, and Data-In PDUs and Nop-In Command PDUs are used as definitions.

The disk array apparatus 2 as peripheral equipment is composed of a host adapter 3 serving as a host interface control device, a cache memory 11 for storing data temporarily, a plurality of magnetic disk devices 13 for holding data, and a disk adapter 12 for controlling the magnetic disk devices 13.

Further, the host adapter 3 is composed of a host IF (interface) controller 4 for controlling transmission/reception of PDUs to the host 1, a cache memory controller 10 for performing data transfer with the cache memory 11, a CPU 8 for controlling the host I/F controller 4 and the cache memory controller 10, and a local memory 9 for storing control programs of the CPU 8 and the PDUs transmitted/received to/from the host 1.

The host I/F controller 4 includes a PDU receiving means 5 for processing commands from the host 1, a PDU transmitting means 6 for transmitting PDUs to the host 1, and a transmitted PDU number counting means 7 for counting the number of PDUs being transmitted to the host 1. The host I/F controller 4 is realized by a network control LSI (including a CPU) or the like.

The host I/F controller 4 serves as a response signal urging means for transmitting response signal urging commands of the number satisfying the prescribed number of commands defined in the standard of the host 1. The transmitted PDU number counting means 7 of the host I/F controller 4 serves as a counting means for counting the number of response signal urging commands transmitted to the host 1. The PDU receiving means 5 of the host I/F controller 4 serves as a receiving means for setting the count number of the counting means back to the initial value. The PDU transmitting means 6 of the host I/F controller 4 serves as a transmitting means for transmitting additional response signal urging commands to the host 1, when the number of response signal urging commands counted by the counting means does not reach the prescribed number, on the basis of a signal from the transmitted PDU number counting means 7. The CPU 8 of the host I/F controller 4 serves as a controller, which controls whether or not to operate the host I/F controller 4, that is, a response signal urging means, on the basis of a control signal inputted from the outside. The control signal is inputted from the outside of the disk array apparatus over the TCP/IP network 14.

Next, operations of the command processing in the host adapter 3 will be described with reference to FIG. 3 and FIGS. 4 to 9.

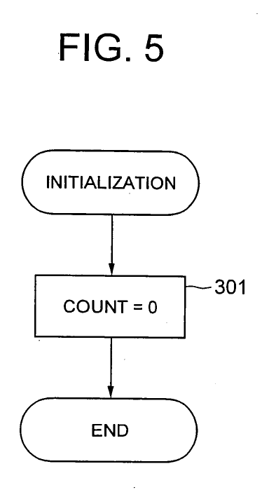

FIG. 5 is a flowchart showing initialization processing.

When activated, the host adapter 3 first initializes the variable COUNT to “0” (Step 301). Then, the host adapter 3 waits to receive a command from the host 1.

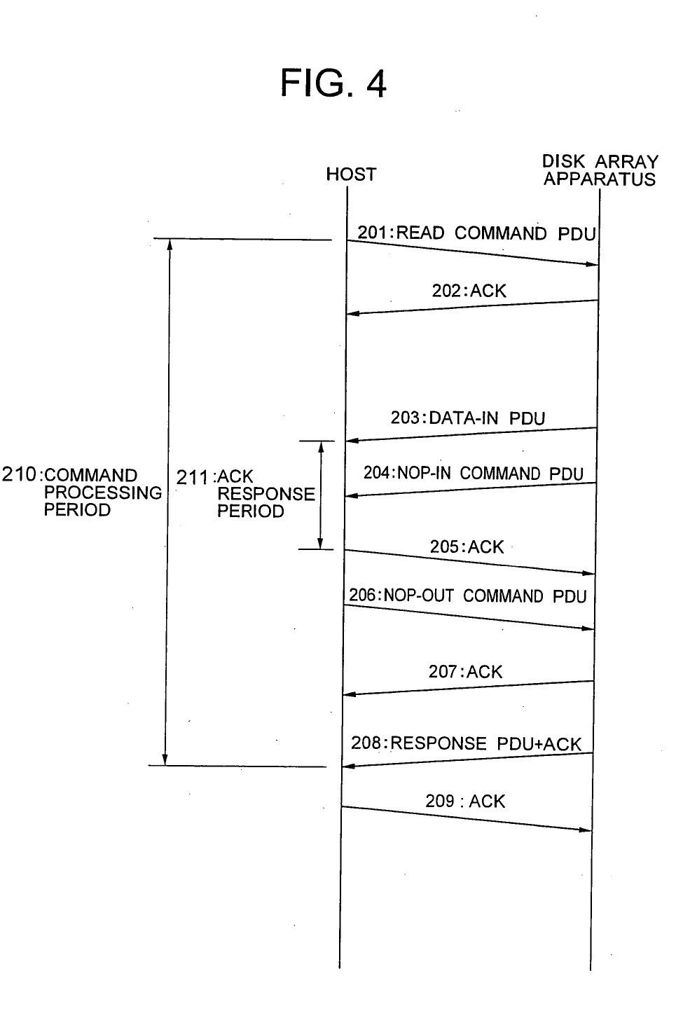

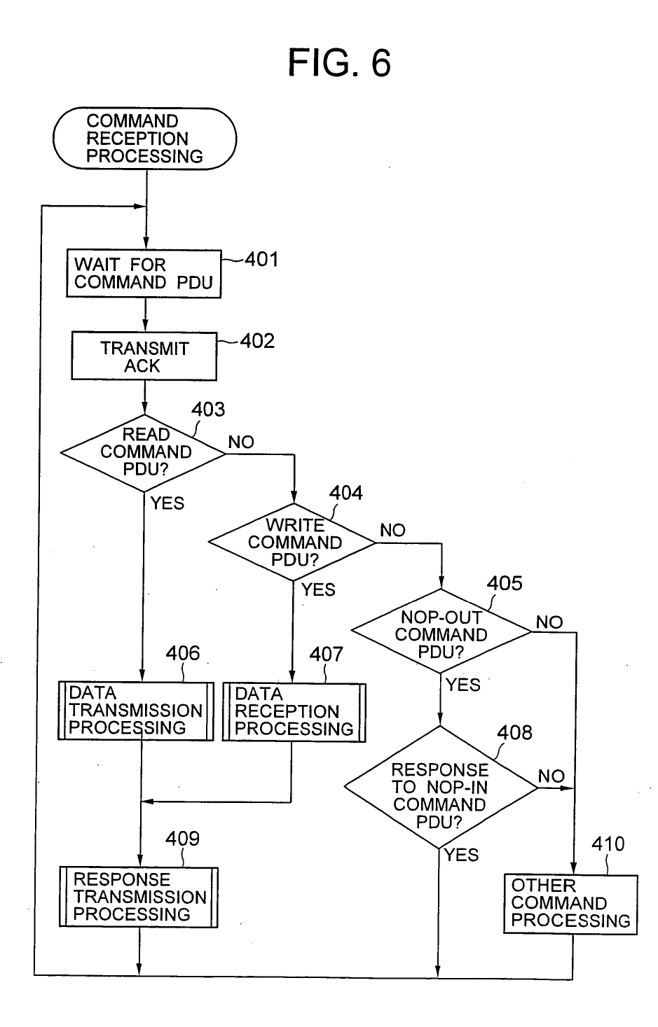

FIG. 4 is a sequential chart showing the interface flow of the Read Command. FIG. 6 is a flowchart showing a processing flow when a command is received.

The host adapter 3, when received a command from the host 1 (Steps 201, 401), transmits an ACK signal to the host 1 as a response (Steps 202, 402).

Then, if the command is a Read Command PDU (Steps 201. 403), the host adapter 3 performs data transmission processing (Step 406), and transmits a response (Steps 208, 409). Then, the host adapter 3 again waits to receive a command from the host 1.

If the command is a Write Command PDU (Step 404), the host adapter 3 performs data reception processing (Step 407), and transmits a response (Step 409). Then, the host adapter 3 again waits to receive a command from the host 1.

If the command is a Nop-Out Command PDU (Steps 206, 405) and is a response to a Nop-In Command PDU transmitted from the disk array apparatus 2 (Step 408), the host adapter 3 keeps waiting to receive a command from the host 1.

If the command is other than the aforementioned one, the host adapter 3 performs processing corresponding to the command (Step 410), and again waits to receive a command from the host 1.

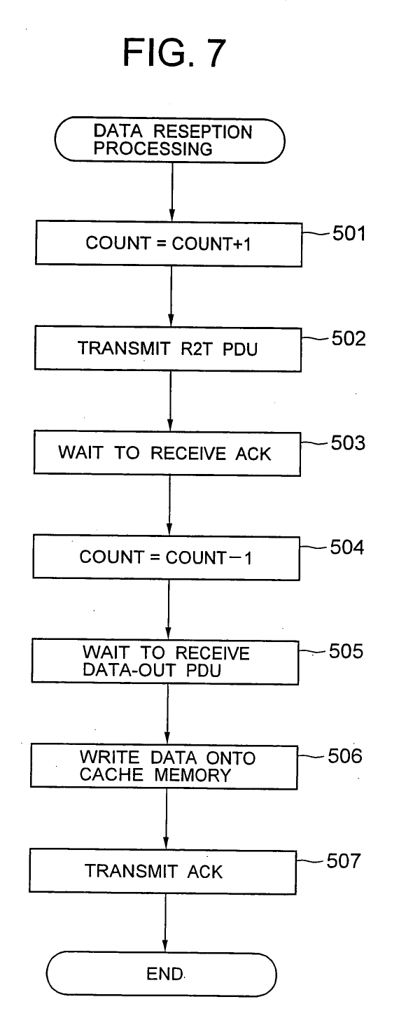

FIG. 7 is a flowchart showing the details of the data reception processing (Step 407).

First, the host adapter 3 adds “1” to the variable COUNT (Step 501), and transmits an R2T PDU to the host 1 (Step 502), then waits for an ACK signal (Step 503). Upon receipt of an ACK signal from the host 1, the host adapter subtracts “1” from the variable COUNT (Step 504). Then, upon receipt of a Data-Out PDU from the host 1 (Step 505), the host adapter 3 writes the received data on the cache memory 11 (Step 506), and transmits an ACK signal to the host 1 (Step 507).

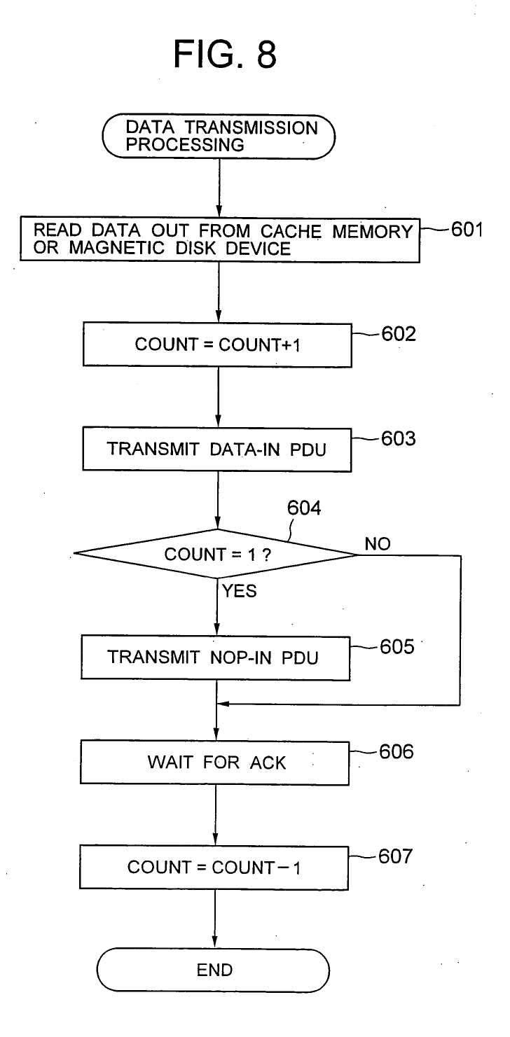

FIG. 8 is a flowchart showing the details of the data transmission processing (Step 406).

The host adapter 3 reads data, from the cache memory 11 if the transmission data hits the cache, or from the magnetic disc device 13 if a mishit of the transmission data occurs in the cache, respectively (Step 601). Then, the host adapter adds “1” to the variable COUNT (Step 602), and transmits a Data-In PDU to the host 1 (Steps 203, 603). Here, if the variable COUNT is “1”, the host adapter 3 continuously transmits a Nop-In Command PDU (Steps 204, 605), and waits for an ACK signal from the host 1 (Step 606). In contrast, if the variable COUNT is other than “1”, the host adapter 3 waits for an ACK signal from the host 1 without transmitting a Nop-In Command PDU (Step 606). Upon receipt of the ACK signal (Step 205), the host adapter 3 subtracts “1” from the variable COUNT (Step 607).

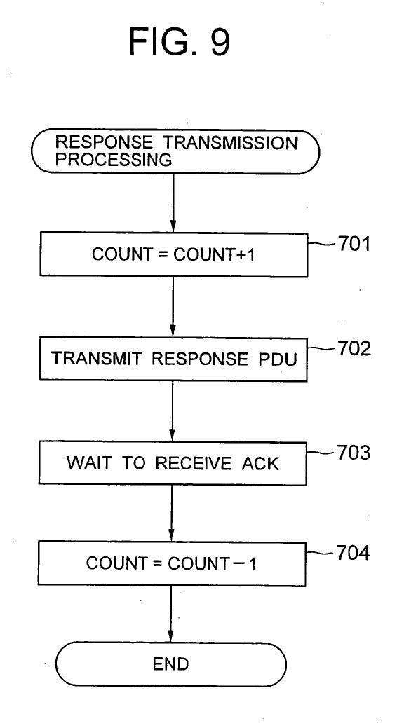

FIG. 9 is a flowchart showing the details of the response transmission processing (Step 409).

First, the host adapter 3 adds “1” to the variable COUNT (Step 701). Then, the host adapter transmits a Response PDU to the host 1 (Step 702), and waits for an ACK signal (Step 703). Upon receipt of the ACK signal from the host 1, the host adapter subtracts “1” from the variable COUNT (Step 704).

In this way, a Nop-In PDU is transmitted only when only one PDU is transmitted from the disk array apparatus 2 to the host 1. Thereby, it is possible to save processing periods for host set-up processing, disk recognition processing, batch processing by applications, and the like.

The present invention can apply not only to disk array apparatuses but also to target apparatuses in general used for the iSCSI protocol.

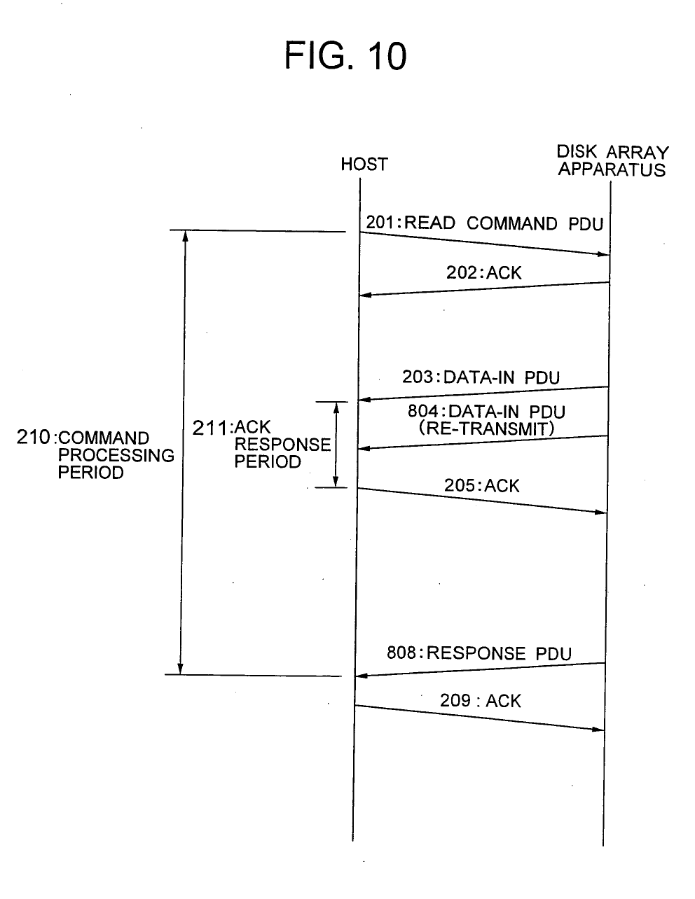

FIG. 10 is a sequential chart showing the interface flow of a Read Command in a second embodiment of the present invention. Hereafter, an explanation will be given with reference to this Figure.

It is possible to use another packet instead of transmitting a Nop-In PDU, if it can hasten a response to an ACK signal from the Host 1.

For example, the Data-In PDU transmitted just before may be resent instead of a Nop-In PDU. FIG. 10 shows the interface flow at the time, in which a transmission of a Nop-In Command PDU in FIG. 4 (Step 204) is substituted by a resent packet of Data-In PDU (step 804). Here, if a resent packet of Data-In PDU is used, the host 1 will discard the resent packet from the disk array apparatus 2. Thus, it is possible to omit processing of the Nop-Out Command PDU which is a response to the Nop-In Command PDU (Steps 206, 207). Further, it is also possible to omit an ACK response (Step 208) to the Nop-Out Command PDU at the time of transmitting a Response PDU (Step 808).

In this way, by transmitting a resent packet of Data-In PDU when only one PDU is transmitted from the disk array apparatus 2 to the host 1, it is possible to save processing periods for host set-up processing, disk recognition processing, batch processing by applications, and the like.

Further, instead of using a method of determining whether or not to transmit a Nop-In Command PDU by counting the transmitted number of packets, a determination of whether or not to transmit a Nop-In Command PDU can be changed by an instruction (control signal) from the outside of the disk array apparatus 2.

Finally, effects of the first and second embodiments will be described. A first effect is, when the host 1 issues only one Read Command, the command processing period can be saved by hastening a transmission of an ACK signal from the host 1 by transmitting a Nop-In Command PDU after transmitting a Data-In PDU. A second effect is that it is possible not to increase the load on the network when the host 1 issues plural commands, by switching the determination of whether or not to transmit a Nop-In Command PDU through counting the number of PDUs transmitted from the disk array apparatus 2.

1. A network system comprising:
a host computer which outputs a response signal corresponding to a command in accordance with a standard; and
peripheral equipment which is connected with the host computer over a communication network and outputs the command to the host computer, wherein
the standard of the host computer is so defined as to delay a transmission of the response signal corresponding to the command from the peripheral equipment until either of conditions is satisfied: a prescribed time period has elapsed since the host computer received the command; and a number of commands outputted from the peripheral equipment reaches a prescribed number, and
the peripheral equipment has response signal urging means for transmitting response signal urging commands of a number satisfying the prescribed number of commands defined in the standard of the host computer.

2. The network system, as claimed in claim 1, wherein the response signal urging means comprises:
counting means for counting a number of response signal urging commands transmitted to the host computer;
receiving means for setting a count number of the counting means back to an initial value by using the response signal from the host computer as a trigger; and
transmitting means for, when the number of response signal urging commands counted by the counting means is less than the prescribed number defined in the standard, transmitting an additional response signal urging command to the host computer.

3. The network system, as claimed in claim 1, further comprising control means, into which a control signal for determining whether or not to operate the response signal urging means is inputted, and which controls the response signal urging means according to the control signal.

4. The network system as claimed in claim 1, wherein
the communication network is a TCP/IP network,
the standard is iSCSI,
the host computer outputs an ACK signal as a response signal responding to a command from the peripheral equipment, and outputs a Delayed ACK as a signal to delay a transmission of the response signal,
the command outputted from the peripheral equipment to request the host computer for a response is a Data-In PDU, and
as the response signal urging command, a Nop-In Command PDU or a Data-In PDU is used.

5. A host interface control device of peripheral equipment which is connected over a communication network with a host computer outputting a response signal corresponding to a command in accordance with a standard, and outputs the command to the host computer, wherein
the standard of the host computer is so defined as to delay a transmission of the response signal corresponding to the command from the peripheral equipment until either of conditions is satisfied: a prescribed time period has elapsed since the host computer received the command; and a number of commands outputted from the peripheral equipment reaches a prescribed number, and
the host interface control device has response signal urging means for transmitting response signal urging commands of a number satisfying the prescribed number of commands defined in the standard of the host computer.

6. The host interface control device, as claimed in claim 5, wherein the response signal urging means comprises:
counting means for counting a number of response signal urging commands transmitted to the host computer;
receiving means for setting a count number of the counting means back to an initial value by using the response signal from the host computer as a trigger; and
transmitting means for, when the number of response signal urging commands counted by the counting means is less than the prescribed number defined in the standard, transmitting an additional response signal urging command to the host computer.

7. The host interface control device, as claimed in claim 5, further comprising control means, into which a control signal for determining whether or not to operate the response signal urging means is inputted, and which controls the response signal urging means according to the control signal.

8. A networking method comprising the steps of:
delaying, by a host computer received a command inputted over a communication network from peripheral equipment, a transmission of a response signal corresponding to the command from the peripheral equipment until either of conditions is satisfied: a prescribed time period has elapsed since the host computer received the command; and a number of commands outputted from the peripheral equipment reaches a prescribed number; and
transmitting, by the peripheral equipment, response signal urging commands of a number satisfying the prescribed number of commands defined in the standard of the host computer.

9. The networking method, as claimed in claim 8, wherein the step of transmitting includes the steps of:
counting a number of response signal urging commands transmitted to the host computer;
setting a count number, counted in the step of counting, back to an initial value by using the response signal from the host computer as a trigger; and
when the number of response signal urging commands counted in the step of counting is less than the prescribed number defined in the standard, transmitting an additional response signal urging command to the host computer.

10. The networking method, as claimed in claim 8, further comprising a step of determining whether or not to perform the step of transmitting the response signal urging commands.

11. The networking method, as claimed in claim 8, wherein
a TCP/IP network is used as the communication network,
the standard causing the response signal outputted from the host computer to be delayed is iSCSI,
the host computer outputs an ACK signal as the response signal responding to the command transmitted from the peripheral equipment, and outputs a Delayed ACK as a signal to delay a transmission of the response signal,
a Data-In PDU is used as the command outputted from the peripheral equipment to request the host computer for a response, and
a Nop-In Command PDU or a Data-In PDU is used as the response signal urging command.

12. A host interfacing method, which is used in a networking method in which a host computer, received a command inputted over a communication network from peripheral equipment, delays a transmission of a response signal corresponding to the command from the peripheral equipment until either of conditions is satisfied: a prescribed time period has elapsed since the host computer received the command; and a number of commands outputted from the peripheral equipment reaches a prescribed number, the method comprising the step of,
transmitting, by the peripheral equipment, response signal urging commands of a number satisfying the prescribed number of commands defined in the standard of the host computer.

13. The host interfacing method, as claimed in claim 12, wherein the step of transmitting includes the steps of:
counting a number of response signal urging commands transmitted to the host computer;
setting a count number, counted in the step of counting, back to an initial value by using the response signal from the host computer as a trigger; and
when the number of response signal urging commands counted in the step of counting is less than the prescribed number defined in the standard, transmitting an additional response signal urging command to the host computer.

14. The host interfacing method, as claimed in claim 12, further comprising a step of determining whether or not to perform the step of transmitting the response signal urging commands.

15. A network control program including:
a function of causing a host computer, which received a command inputted over a communication network from peripheral equipment, to delay a transmission of a response signal corresponding to the command from the peripheral equipment until either of conditions is satisfied: a prescribed time period has elapsed since the host computer received the command; and a number of commands outputted from the peripheral equipment reaches a prescribed number; and
a function of causing the peripheral equipment to transmit response signal urging commands of a number satisfying the prescribed number of commands defined in the standard of the host computer.

16. The network control program, as claimed in claim 15, further including a function of causing the peripheral equipment to determine whether or not to transmit the response signal urging commands.

17. A host interface control program for transmitting a command to a host computer which received a command inputted from peripheral equipment over a communication network, wherein
a standard of the host computer is so defined as to delay a transmission of a response signal corresponding to the command from the peripheral equipment until either of conditions is satisfied: a prescribed time period has elapsed since the host computer received the command; and a number of commands outputted from the peripheral equipment reaches a prescribed number, and
the program includes a function of causing the peripheral equipment to transmit response signal urging commands of a number satisfying the prescribed number of commands defined in the standard of the host computer.

18. The host interface control program, as claimed in claim 17, further including, in a process of causing the peripheral equipment to execute the function of transmitting the response signal urging commands,
a function of counting a number of response signal urging commands transmitted to the host computer;
a function of setting a count number, counted in the step of counting, back to an initial value by using the response signal from the host computer as a trigger; and
a function of transmitting an additional response signal urging command to the host computer when the number of response signal urging commands, counted in the step of counting, is less than the prescribed number defined in the standard.

19. The host interface control program, as claimed in claim 17, further including a function of determining whether or not to execute the function of causing the peripheral equipment to transmit the response signal urging commands.
